(19) United States
(12) Patent Application Publication
(10) Pub. No.: US 2005/0112350 A1
(43) Pub. Date: May 26, 2005

(54) Biodegradable and breathable polymer film

(76) Inventor: Xin Ning, Alpharetta, GA (US)

Correspondence Address: KIMBERLY-CLARK WORLDWIDE, INC., 401 NORTH LAKE STREET, NEENAH, WI, 54956, US

(21) Appl. No.: 10/718,762

(22) Filed: Nov. 21, 2003

(51) Int. Cl. B32B 3/26; B32B 5/22

(52) U.S. Cl. 428/304.4; 428/317.9

(57) ABSTRACT

A composition for a film which is both biodegradable and breathable and films prepared from the composition and then stretched are disclosed. The film comprises from about 30% to about 70% by weight of a biodegradable copolyester and from 70% to about 30% by weight of a filler, and the film is stretched in either a monoaxial or biaxial direction to increase void formation and achieve a water vapor transmission rate (WVTR) of at least 800 grams per square meter per 24 hours, and more particularly a WVTR of greater than 1900 grams per square meter per 24 hours. The copolyester is typically a copolyester of aliphaticlaromatic acids and the filler is typically calcium carbonate. The film is suitable for use in disposable breathable products such as personal care products, absorbent products, health care products, bandages and medical fabrics.

### FIELD

The present invention is generally related to biodegradable polymer film compositions and more particularly to breathable biodegradable polymer film compositions.

### BACKGROUND OF THE INVENTION

Polymer films are useful in making a variety of disposable articles because they are relatively inexpensive to manufacture, and can be made to be strong, durable, flexible, soft, and a barrier to aqueous liquids such as water. Examples of such disposable products or articles include, but are not limited to, medical and health care products such as surgical drapes, gowns and bandages, protective workwear garments such as coveralls and lab coats, and infant, child and adult personal care absorbent articles such as diapers, training pants, disposable swimwear, incontinence garments and pads, sanitary napkins, wipes and the like. Other uses polymeric film materials include geotextiles. It is often highly desirable for polymeric films used in such product applications to be both liquid impervious and breathable.

It is known that breathable films can be prepared by blending an organic or inorganic incompatible filler with a polyolefin-based resin, which is then melted, film-formed and stretched. These films are mainly used as liquid barriers in disposable personal care products, which are discarded immediately after use. However, the breathable films prepared from polyolefin-based resin cannot be degraded in the natural environment.

There is an increasing demand for the incorporation of more recyclable and/or degradable components in disposable products, and the design of products that can be disposed of by means other than by incorporation into solid waste disposal facilities such as landfills. As such, there is a need for new materials for disposable absorbent products that generally retain their integrity and strength during use, but after such use, are more efficiently disposable. For example, the disposable absorbent product may be easily and efficiently disposed of by composting. Alternatively, the disposable absorbent product may be easily and efficiently disposed of to a liquid sewage system wherein the disposable absorbent product is capable of being degraded.

While it is possible to enhance the breathability and biodegradability of polymer films separately, enhancing the biodegradability of polymer films, without diminishing the breathability of the films, is difficult. For example, biodegradable films derived from copolyesters are known in the art. These films tend to be very flexible and ductile, with high elongation at break. However, due to the extremely ductile nature of these compounds, pore formation in such films is much less pronounced than in comparable polyethylene-based compositions, resulting in a water vapor transmission rate (WVTR) below 400 grams per square meter per 24 hours in the stretched films. This does not compare favorably with breathability values of up to 20,000 WVTR which can be attained in stretched films based on polyethylene compositions. These copolyester films are therefore not suitable for breathable personal care products, but are rather more suited for use as refuse bags, in packaging applications and the like.

Thus, while biodegradable films are known, these films fail to provide the same or substantially similar properties of high permeability to water vapor as the currently used breathable (but not biodegradable) polyethylene films.

Accordingly, there remains a need for a composition which can be used to manufacture a biodegradable film which is also breathable, for use in making disposable or single-use articles of manufacture.

### SUMMARY OF THE INVENTION

The present invention provides a biodegradable, breathable film and a process for manufacturing a biodegradable, breathable film. The film may comprise from about 30 percent to about 70 percent by weight of a biodegradable copolyester and about 70 percent to about 30 percent by weight of a filler, where the film is stretched in at least a monoaxial direction to achieve a WVTR of at least about 800 grams per square meter per 24 hours. In another embodiment, the film has from about 40 to about 55 weight percent copolyester and from about 60 to about 40 weight percent filler. In still another embodiment, the film may have WVTR of at least about 1900 grams per square meter per 24 hours.

The biodegradable, breathable film may include copolyesters of aliphatic/aromatic acids as the copolyester and calcium carbonate as the filler.

In certain embodiments, the filler may have an average particle size in the range of about 0.1 to about 7 micrometers, and in other embodiments the filler may have an average particle size in the range of about 0.8 to about 2.6 micrometers.

The biodegradable, breathable film may further include a compatibilizer, and the compatibilizer may be such as a fatty acid, unsaturated fatty acid, amide thereof, silane coupling agent, alkyl titanate, and so forth.

The film may be stretched in a monoaxial direction to obtain a stretch ratio of from about less than 1× to about 5× in the machine direction (MD), for example about 200 percent or 250 percent. The film may optionally also be stretched in a biaxial direction so as to obtain a stretch ratio which is desirably in the range of from less than 1× by 1× to about 3× by 3× in the cross-machine direction (CD).

The process for manufacturing the biodegradable and breathable film includes the steps of melt blending from about 30 percent to about 70 percent by weight of a biodegradable copolyester and from about 70 percent to about 30 percent by weight of a filler to form a resin, film forming the resin to form a film, and then stretching the film in at least a monoaxial direction so as to achieve a water vapor transmission rate of at least 800 grams per square meter per 24 hours. In embodiments, the film may desirably be stretched biaxially.

Further provided are laminates and disposable articles of manufacture comprising the biodegradable, breathable film, such articles as for example medical products, protective garments and personal care absorbent articles.

### BRIEF DESCRIPTION OF THE DRAWINGS

FIG. 1 is an illustration in partial cut away view of a laminate material comprising the breathable and biodegradable film of the invention.

FIG. 2 is a perspective view of a disposable diaper comprising the breathable and biodegradable film of the invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of.”

As used herein, “biodegradable” is meant to represent that a material degrades from exposure to air and/or water or from the action of naturally occurring microorganisms such as bacteria, fungi and algae.

As used herein, the term “breathability” refers to the water vapor transmission rate (WVTR) of an area of film. Breathability is measured in grams of water per square meter per day.

As used herein, the term “breathable” refers to a film having a WVTR of at least 800 grams of water per square meter per day.

As used herein, the term “copolymer” generally includes but is not limited to, block, graft, random and alternating copolymers and blends and modifications thereof.

As used herein, the term “filler” is meant to include particulates and other forms of materials which can be added to the film blend and which will not chemically interfere with or adversely affect the extruded film but which are able to be uniformly dispersed throughout the film. Fillers known in the art include particulate inorganic materials such as for example talc, calcium carbonate, barium carbonate, magnesium carbonate, magnesium sulfate, titanium dioxide, mica, clays, kaolin, diatomaceous earth and the like, and organic particulate materials such as powdered polymers for example TEFLON and KEVLAR, and wood and other cellulose powders.

As used herein, the term “personal care product” means personal hygiene oriented items such as wipes, diapers, training pants, absorbent underpants, adult incontinence products, feminine hygiene products, and so forth.

### DETAILED DESCRIPTION OF THE INVENTION

The invention provides a composition including a biodegradable copolyester and a filler, the composition being suitable for manufacturing biodegradable films which are also breathable when stretched in either a monoaxial or biaxial direction. Such films have good mechanical and biodegradable properties compared to films made from the copolyester alone.

Other additives and ingredients may be added to the film layer provided they do not seriously interfere with the ability of the film to be breathable or biodegradable. For example, a compatibilizer such as a fatty acid (e.g. stearic acid, oleic acid or behenic acid), unsaturated fatty acid, amide thereof (e.g. erucamide or oleamide), silane coupling compound, alkyl titanate, and so forth may be added to enhance the mechanical properties of the film. Colorants, reinforcements and other types of fillers may also be added.

Suitable copolyesters are those having good physical properties and biodegradability. Such copolyesters are disclosed in European Pat. No. EP 1 106 640 and European Pat. No. EP 1 108 737, both to Chung et al., in which copolyesters are prepared by the reaction of (i) 0.1 weight percent to 30 weight percent of an oligomer-like aromatic-aliphatic prepolymer having an average molecular weight of from 300 to 30,000; (ii) 40 weight percent to 71 weight percent of one or more aliphatic or alicyclic dicarboxylic acids or anhydrides; and (iii) 29 weight percent to 60 weight percent of one or more aliphatic or alicyclic glycerols. Specific examples of suitable aliphatic/aromatic copolyesters are ENPOL® G8060 and IRE® 8000 from Ire Chemical Ltd of Seoul, South Korea, and EASTAR® from Eastman Chemical of Kingsport, Tenn., USA.

Generally the filler will be an inorganic filler in particulate form and usually will have somewhat of a spherical shape with an average particle size in the range of about 0.1 to about 7 micrometers, and more particularly in the range of about 0.5 to about 2.6 micrometers. Examples of inorganic fillers include calcium carbonate, magnesium carbonate, barium carbonate, magnesium sulfate, barium sulfate, calcium sulfate, zinc oxide, magnesium oxide, calcium oxide, titanium oxide, barium oxide, aluminum oxide, aluminum hydroxide, hydroxyapatite, silica, mica, talc, kaolin, clay, glass powder, asbestos powder, zeolite and acid clay. Particularly desirable inorganic fillers are calcium carbonate, magnesium oxide, barium sulfate, silica and acid clay. Calcium carbonate can be obtained from English China Clay (trading as Imerys) of Roswell, Ga., USA, or from Omya of Florence, Vt., USA.

Generally, on a dry weight basis, based upon the total weight of the film, the composition will include from about 30 to about 70 weight percent copolyester and from about 70 to about 30 weight percent filler. More desirably, the composition will include from about 40 to about 55 weight percent copolyester and from about 60 to about 40 weight percent filler. For example, the copolyester and filler may be present in a ratio of 50:50 by weight.

In order to provide uniform breathability as reflected by the water vapor transmission rate (WVTR) of the film, the filler should be substantially uniformly dispersed throughout the composition and, consequently, throughout the film itself.

The copolyester and filler may be mixed in appropriate proportions given the ranges outlined above and then compounded and extruded into a film layer using any one of a variety of film-producing processes known to those of ordinary skill in the art, including casting and blowing. The composition may alternatively be pelletized prior to the film-forming step, instead of the film being obtained directly from the extruder. The extrusion temperature may desirably be in the range of from about 180 degrees Celsius to about 270 degrees Celsius, and more desirably in the range of from about 200 degrees Celsius to about 250 degrees Celsius, for example, about 220 degrees Celsius.

The film may then be stretched in a monoaxial direction to obtain a stretch ratio of from about less than 1× to about 5× in the machine direction (MD), for example about 200 percent or 250 percent, as detailed more fully in U.S. Pat. Nos. 5,695,868 and 5,855,999 both to McCormack, incorporated herein by reference in their entireties, in order to make it porous. The film may optionally also be stretched in a biaxial direction (i.e. in both longitudinal and lateral directions) so as to obtain a stretch ratio which is desirably in the range of from less than 1× by 1× to about 3× by 3× in the cross-machinedirection (CD), for example, about 64 percent by 64 percent. The stretching temperature may be in the range of from 20 to about 100 degrees Celsius, for example, 22, 30 or 70 degrees Celsius.

By stretching the film, void formation in the film is enhanced and hence the film is made more porous and breathable. Biaxial stretching of the film produces even greater void formation and hence enhanced breathability of the film.

For purposes of the present invention, a film is “breathable” if it has a WVTR of at least 800 grams per square meter per 24 hours as calculated using the MOCON® test method, which is described in more detail below. The WVTR of the film of this invention is within the range from about 800 to about 15,000 grams per square meter per 24 hours, is more desirably within the range of 1,900 to 15,000 grams per square meter per 24 hours, and is even more desirably at least about 2,500 grams per square meter per 24 hours.

Generally, once the film is formed, it will have a weight per unit area of less than about 100 grams per square meter, and after stretching and thinning its weight per unit area or basis weight will desirably be less than about 35 grams per square meter. In some embodiments, the basis weight will desirably be less than about 25 grams per square meter, and more desirably less than about 20 grams per square meter, and still more desirably less than about 17 grams per square meter.

The thickness of the film may differ depending upon its uses and is generally in the range of from about 10 to about 300 micrometers.

The film has an elongation at break of at least about 10 percent and, more desirably at least about 200 percent.

As a result, while not meaning to be limited to the specific uses as herein specified, the film of the present invention has particular use as a backing material for personal care items, absorbent products, health care products, medical fabrics and the like.

MOCON® Water Vapor Transmission Rate Test:

A suitable technique for determining the water vapor transmission rate (WVTR) value of a material is the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the PERMATRAN-W® model 100K manufactured by Modern Controls, Inc (MOCON®) of Minneapolis, Minn., USA. A first test is made of the WVTR of the guard film and air gap between an evaporator assembly that generates 100 percent relative humidity. Water vapor diffuses through the air gap and the guard film and then mixes with a dry gas flow which is proportional to water vapor concentration. The electrical signal is routed to a computer for processing. The computer calculates the transmission rate of the air gap and guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material.

This information is then used to calculate the transmission rate at which moisture is transmitted through the test material according to the equation:
TR⁻¹_{test material}=TR⁻¹_{test material, guardfilm, airgap}−TR⁻¹_{guardfilm, airgap}

The calculation of the WVTR uses the formula:
WVTR=Fρₛₐₜ(T)RH/Apₛₐₜ(T)(1−RH)
where:

F=the flow of water vapor in cc/min,

ρₛₐₜ(T)=the density of water in saturated air at temperature T,

RH=the relative humidity at specified locations in the cell,

A=the cross sectional area of the cell, and

pₛₐₜ(T)=the saturation vapor pressure of water vapor at temperature T.

The invention will now be described in more detail by way of the following non-limiting examples, which are designed to illustrate particular aspects of the invention and teach one of ordinary skill in the art how to carry out the invention.

### EXAMPLES

### Example 1

A biodegradable copolyester polymer resin, ENPOL® G8060 was obtained from Ire Chemical Ltd of South Korea. ENPOL® G8060 is a fully biodegradable aromatic/aliphatic copolyester having a melting point of 127 degrees Celsius, a melt index of 1.4-5 g/10 min at 190 degrees Celsius and 2160 g load.

Two biodegradable films (A and B, respectively) were prepared and evaluated to determine the water vapor transmission rate (WVTR) of each film. Film A was prepared using calcium carbonate obtained from English China Clay, and film B was prepared using calcium carbonate obtained from Omya (OMYACARB® 2SST).

The copolyester was compounded with the calcium carbonate in a 50:50 weight percent ratio, using a twin screw extruder. The composition was then melt extruded into films of about 20 micrometer thickness. The extrusion temperature was in the range of from about 180 to about 270 degrees Celsius, and more desirably in the range of from about 200 to about 250 degrees Celsius.

(a) First samples of each of films A and B (samples A1 and B1, respectively) were placed into a conventional machine direction orientation unit (MDO), such as that manufactured by the Marshall and Williams Company, where they were stretched in the machine direction (MD) as described in U.S. Pat. No. 5,695,868 and U.S. Pat. No. 5,855,999, both to McCormack, so as to obtain a stretch percentage of 250 percent. The stretching was performed in an oven at a temperature of 70 degrees Celsius. After stretching, heat setting was carried out in order to enhance form stability of the pores.

The stretch ratio was defined as:
Stretch percent=(final film length−original length)/original length×100

(b) Second samples of each of films A and B (samples A2 and B2, respectively) were placed into the same MDO unit and were stretched in the MD direction so as to obtain a stretch percentage of 200 percent at 30 degrees Celsius.

The WVTR of the films was measured in accordance with the MOCON® method described above. The results are shown in Table 1.

TABLE 1
Monoaxial stretching of film samples

| Film Sample | Stretch Ratio | Stretch Temperature | WVTR |
|---|---|---|---|
| A1 | 250 percent | 70 degrees Celsius | 1900 |
| A2 | 200 percent | 30 degrees Celsius | 2232 |
| B1 | 250 percent | 70 degrees Celsius | 2553 |
| B2 | 200 percent | 30 degrees Celsius | 2477 |

### Example 2

Samples from each of films A and B prepared in Example 1 (samples A3 and B3 respectively) were subjected to biaxial stretching. The films were fed through a set of intermeshing groove rolls at ambient room temperature (about 22 degrees Celsius). The engagement of the rolls created cross-machine directional (CD) extension, the extent of which was measured by the length gain in CD direction. The stretched films were then rotated approximately 90 degrees and again fed through the groove rolls to perform a second direction extension or stretch such that the films had been biaxially extended or stretched. After stretching, heat setting was carried out in order to enhance form stability of the pores.

The stretch ratio was defined by percentage length gain in both directions.

The WVTR measurements were again determined according to the MOCON® method described above, and the results are shown in Table 2.

TABLE 2
Biaxial stretching of film samples.

| Film Sample | Stretch Ratio | Stretch Temperature | WVTR |
|---|---|---|---|
| A3 | 64 percent by 64 percent | 22 degrees Celsius | 2792 |
| B3 | 64 percent by 64 percent | 22 degrees Celsius | 3501 |

The examples above indicate that a biodegradable film can be produced having a good WVTR value and hence good breathability. Further, the breathability of the films is markedly enhanced when the films are biaxially stretched. Such breathable and biodegradable films are highly useful for use in single-use or disposable articles and products where a fluid impervious barrier is required but the barrier is also desirably breathable. Examples of such products include, but are not limited to, medical and health care products such as surgical drapes, gowns and bandages, protective workwear garments such as coveralls and lab coats, and infant, child and adult personal care absorbent articles such as diapers, training pants, disposable swimwear, incontinence garments and pads, sanitary napkins, wipes and the like. Other uses for such breathable and biodegradable polymeric film materials may include geotextiles. While not described in detail herein, various additional potential processing and/or finishing steps known in the art such as aperturing, slitting, further stretching, treating, or lamination of the breathable and biodegradable polymeric film materials with other films or with nonwoven web layers, may be performed without departing from the spirit and scope of the invention.

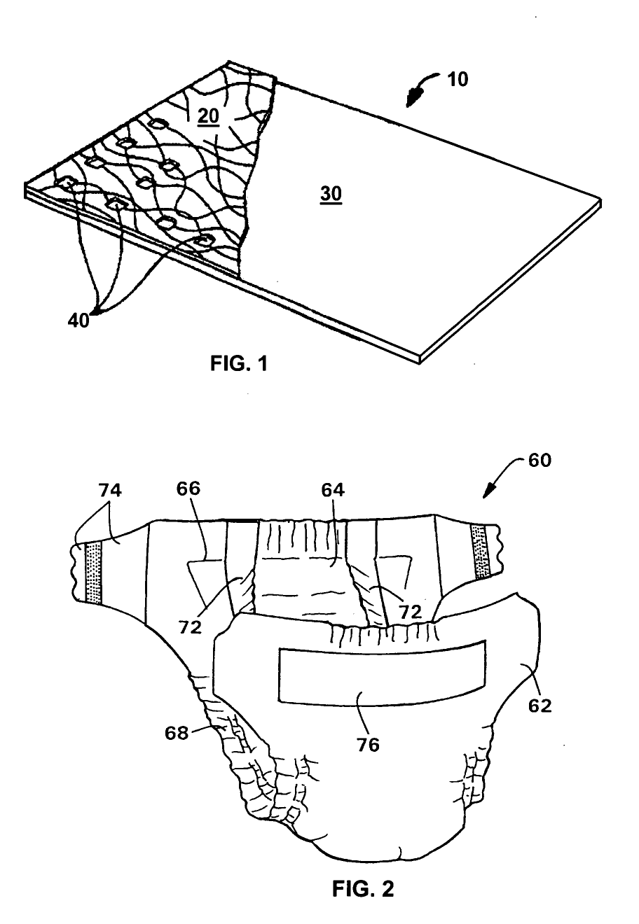

Examples of lamination of the breathable and biodegradable polymeric film materials with other films or nonwoven layers include laminate materials having two or more layers, such as the exemplary bi-layer laminate material shown in FIG. 1. Nonwoven fabrics or webs have been formed from many processes such as for example, meltblowing processes, spunbonding processes, airlaying processes, and carded web processes. FIG. 1 demonstrates a laminate material which is a laminate of the breathable and biodegradable polymeric film with a nonwoven web layer such as, for example, a spunbond web layer bonded to the film. Spunbond nonwoven webs are well known in the art and will not be described herein in detail. Briefly, spunbond refers to a nonwoven fiber or filament material of small diameter filaments that are formed by extruding molten thermoplastic polymer as filaments from a plurality of capillaries of a spinneret. The extruded filaments are cooled while being drawn by an eductive or other well known drawing mechanism. The drawn filaments are deposited or laid onto a forming surface in a generally random manner to form a loosely entangled filament web, and then the laid filament web is subjected to a bonding process to impart physical integrity and dimensional stability. The production of spunbond fabrics is disclosed, for example, in U.S. Pat. No. 4,340,563 to Appel et al., U.S. Pat. No. 3,692,618 to Dorschner et al., and U.S. Pat. No. 3,802,817 to Matsuki et al., all of which are incorporated herein by reference in their entireties. Typically, spunbond fibers or filaments have a weight-per-unit-length in excess of about 1 denier and up to about 6 denier or higher, although both finer and heavier spunbond filaments can be produced. In terms of filament diameter, spunbond filaments often have an average diameter of larger than 7 microns, and more particularly between about 10 and about 25 microns, and up to about 30 microns or more.

FIG. 1 is a schematic only, simply illustrative of one of the types of laminates intended. Generally, such multi-layer nonwoven-film laminate materials have a basis weight of from about 3 to about 400 grams per square meter, or more particularly from about 15 grams per square meter to about 150 grams per square meter. As shown in FIG. 1, the bi-layer laminate material is generally designated 10 and comprises breathable and biodegradable polymeric film layer 30 to which is attached a nonwoven web layer 20. As is known to one skilled in the art, such laminates may be laminate bonded by, for example, adhesive bonding, ultrasonic bonding, or thermal bonding such as thermal point or “spot” bonding. Additionally shown in FIG. 1 are bond points 40 such as may be made by a thermal spot bonding process, which bond or mate the two materials of the laminate together at spaced apart locations in a pattern of spots. Adhesive bonding as is known in the art may be particularly advantageous where the component layers of the laminate to be bonded together do not thermally bond well together, as where the components have disparate melting points or softening temperatures. In addition, it should be noted that the breathable and biodegradable films may also be laminated as part of a tri-laminate material such as a nonwoven/film/nonwoven laminate material. Such a tri-laminate material may be particularly desirable in applications, such as for example in disposable medical fabrics, where it is useful to have a more cloth-like layer on both sides of the breathable barrier film layer.

As was mentioned, the breathable and biodegradable polymeric film materials of the invention are also highly suitable for use in personal care absorbent articles. Turning to FIG. 2 there is shown an exemplary personal care article such as the diaper 60. Diaper 60, as is typical for most personal care absorbent articles, includes a liquid permeable body side liner 64, i.e., a body-facing or inner side, and a liquid impermeable outer cover 62, i.e., a non-body facing or outer side. Various woven or nonwoven fabrics can be used for body side liner 64 such as a spunbond nonwoven web of polyolefin fibers, or a bonded carded web of natural and/or synthetic fibers. Liner 64 may also beneficially be a spunbonded web or carded web material comprising the multicomponent fibers of invention. Outer cover 62 is formed of a thin liquid barrier material such as for example the breathable and biodegradable polymeric film materials of the invention. Such a polymer film material outer cover may be embossed and/or matte finished to provide a more aesthetically pleasing appearance, or may be a laminate formed of the breathable and biodegradable film and a woven or nonwoven web material, such as was described above, to provide a more aesthetically pleasing feel and sound or more “cloth-like” characteristics.

Disposed between liner 64 and outer cover 62 is an absorbent core 66 formed, for example, of a blend of hydrophilic cellulosic wood pulp fluff fibers and highly absorbent gelling particles (e.g., superabsorbent material). Absorbent core 66 may further comprise thermoplastic binder fibers as are known in the art. Diaper 60 may further include optional containment flaps 72 made from or attached to body side liner 64. Suitable constructions and arrangements for such containment flaps are described, for example, in U.S. Pat. No. 4,704,116 to Enloe, incorporated herein by reference in its entirety. Still further, the diaper 60 can optionally include additional elements known to those skilled in the art, including but not limited to, elasticized leg cuffs, elastic waist band, and so forth.

To secure the diaper 60 about the wearer, the diaper will have some type of fastening means attached thereto. As shown in FIG. 2, the fastening means is a hook and loop fastening system including hook elements 74 attached to the inner and/or outer surface of outer cover 62 in the back waistband region of diaper 60 and one or more loop elements or patches 76 attached to the outer surface of outer cover 62 in the front waistband region of diaper 60. The loop material for loop patch 76 can be a woven, nonwoven or knitted loop material and may be secured to outer cover 62 of diaper 60 by known attachment means, including but not limited to adhesives, thermal bonding, ultrasonic bonding, or a combination of such means. As an alternative embodiment, a nonwoven loop material may cover all of, or substantially all of, the outer surface of outer cover 62.

While various patents and other reference materials have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover or encompass all such modifications, alterations and/or changes.

1. A biodegradable, breathable film comprising:
about 30 percent to about 70 percent by weight of a biodegradable copolyester; and
about 70 percent to about 30 percent by weight of a filler;
wherein the film is stretched in at least a monoaxial direction to achieve a WVTR of at least about 800 grams per square meter per 24 hours.

2. The film of claim 1, which is stretched in a monoaxial direction so as to obtain a machine direction stretch ratio of from about 2× to about 5×.

3. The film of claim 1, which is stretched biaxially.

4. The film of claim 3, which is stretched so as to obtain a cross-machine direction stretch ratio of from about 1× by 1× to about 3× by 3×.

5. The film of claim 1, wherein the biodegradable copolyester comprises a copolyester of aliphatic/aromatic acids.

6. The film of claim 1, wherein the filler is calcium carbonate.

7. The film of claim 1, wherein the filler is a particulate material having an average particle size in the range of from about 0.1 to about 7 micrometers.

8. The film of claim 1, wherein the filler is a particulate material having an average particle size in the range of from about 0.8 to about 2.6 micrometers.

9. The film of claim 1, which further comprises a compatibilizer.

10. The film of claim 9, wherein the compatibilizer is selected from the group consisting of fatty acids, fatty acid amides, silane compounds and alkyl titanates.

11. The film of claim 9, wherein the compatibilizer comprises from about 0.02 weight percent to about 2 weight percent of the film.

12. The film of claim 1, which comprises from about 40 percent to about 55 percent by weight of the biodegradable copolyester and from about 45 percent to about 60 percent by weight of the filler.

13. The film of claim 1, which has a water vapor transmission rate of greater than about 1900 grams per square meter per 24 hours.

14. The film of claim 12, further comprising at least one additional layer bonded thereto.

15. A disposable article of manufacture comprising a film according to claim 1.

16. The disposable article of claim 15, which is selected from the group consisting of medical products, protective garments and personal care absorbent articles.

17. A process for manufacturing a biodegradable and breathable film, comprising the steps of:
melt blending from about 30 percent to about 70 percent by weight of a biodegradable copolyester and from about 70 percent to about 30 percent by weight of a filler to form a resin;
film forming the resin to form a film; and
stretching the film in at least a monoaxial direction so as to achieve a water vapor transmission rate of at least 800 grams per square meter per 24 hours.

18. The process of claim 17, further including the step of stretching the film in a biaxial direction.

19. The process of claim 17 wherein the inorganic filler is calcium carbonate.

20. The process of claim 17 wherein the biodegradable copolyester comprises a copolyester of aliphatic/aromatic acids.

21. A biodegradable and breathable film made by the process of claim 17.
